(19) United States
(12) Patent Application Publication
(10) Pub. No.: US 2008/0030877 A1
(43) Pub. Date: Feb. 7, 2008

(54) SYSTEMS AND METHODS FOR OPTIMIZING THE CRYSTALLIZATION OF AMORPHOUS SILICON

(75) Inventors: Brandon A. Turk, Escondido, CA (US); Bernd Burfeindt, Ramona, CA (US); David S. Knowles, San Diego, CA (US)

Correspondence Address: BAKER & MCKENZIE LLP;PATENT DEPARTMENT, 2001 ROSS AVENUE, SUITE 2300, DALLAS, TX, 75201, US

(73) Assignee: TCZ GMBH, San Diego, CA (US)

(21) Appl. No.: 11/462,915

(22) Filed: Aug. 7, 2006

(51) Int. Cl. G02B 3/02

(52) U.S. Cl. 359/719

(57) ABSTRACT

In a thin beam directional Crystallization System configured anneal a silicon layer on a glass substrate uses a special laser beam profile with an intensity peak at one edge. The system is configured to entirely melt a spatially controlled portion of a silicon layer causing lateral crystal growth. By advancing the substrate or laser a certain step size and subjecting the silicon layer to successive “shots” from the laser, the entire silicon layer is crystallized. The lateral crystal growth creates a protrusion in the center of the melt area. This protrusion must be re-melted. Accordingly, the step size must be such that there is sufficient overlap between successive shots, i.e., melt zones, to ensure the protrusion is melted. This requires the step size to be less than half the beam width. A smaller step size reduces throughput and increases costs. The special laser profile used in accordance with the systems and methods described herein can increase the step size and thereby increase throughput and reduce costs.

### BACKGROUND

1. Field of the Invention

The field of the invention relates generally to, Liquid Crystal Displays (LCDs), and more particularly to systems and methods for manufacturing LCDs.

2. Background of the Invention

There is already a well-established and growing market for active matrix LCDs, in which an active thin film transistor (TFT) is used to control each pixel in the display. For example, active matrix LCDs are the prevailing technology for computer screens. Additionally, in recent years, active matrix LCD solutions also have made dramatic inroads in market segments such as televisions, mobile phones, PDAs, video recorders, etc.

Active matrix LCDs are predicted to be the fastest growing segment of the display industry, with a projected average annual growth rate of 35 percent over the next five years. In contrast, passive LCDs and conventional cathode ray tubes (CRTs), are predicted to have flat to negative growth rates. The only other display technology predicted to have positive growth is Organic Light Emitting Diode (OLED) displays, which is just now emerging for specialized applications and is predicted to more than double each year beyond 2007.

In addition to rapid overall growth, the nature of the LCD market is changing, i.e., newer LCD applications include more diversity and more special requirements. For example, phones represent approximately 50 percent of all LCDs but only 2 percent of total LCD area. In contrast, monitors represent approximately 27 percent of LCDs but 50 percent of the total area. With rapid growth of TV applications and large screen sizes, televisions are projected to comprise more than 30 percent of the total LCD area by 2008. These large screen applications have many special requirements compared to previous LCD applications.

To support the expected high growth rates and to successfully compete for new market opportunities, LCD manufacturers must be able to leverage emerging display fabrication techniques to improve the features and performance of the LCD offerings, while simultaneously improving production costs and throughput.

As the LCD industry moves into the next phase of rapid growth and product diversity, some factors for success can include smaller pixel size, higher densities, which are a direct function of the size of the TFTs, and higher TFT switching speeds to support video requirements. Brighter display capabilities, improved aperture ratios for more light per pixel, and overall lower production costs are also factors for success. Lower production costs can result from both faster processing throughput and a consistently higher yield of good displays per panel. For long term success, it will be important for LCD manufacturers to invest in technology solutions that can also be cost-effectively adapted for efficient fabrication of emerging high-growth screen types such as OLED.

The two primary process methods that are currently used for creating a conductive layer on a glass substrate that will support the fabrication of TFTs for active matrix LCDs are Amorphous silicon (a-Si) and Low temperature polycrystalline silicon (poly-Si or LTPS). In the a-Si process, a transistor gate is created directly on PECVD Si film. In the poly-Si or LTPS process, the PECVD Si film is crystallized prior to gate fabrication to produce higher performance TFTs. In these processes the temperature is kept low to avoid melting the glass substrate.

Because the movement of electrons is inherently slower through amorphous silicon transistors, a-Si based TFTs have to be physically larger in order to provide sufficient current flow from source to drain. On the other hand, due to the significantly higher electron mobility that can be achieved with poly-silicon, LTPS based TFTs can be smaller and faster. Because poly-silicon transistors are inherently smaller, more light can pass through each pixel. This allows design flexibility to allow for improved aperture ratios, greater pixel densities, or both.

Despite the TFT size and performance advantages of LTPS, most LCD panels today are still fabricated using an amorphous-silicon process. This is due primarily to the relatively lower costs of a-Si that result from fewer process steps and the potential unknowns associated with less mature LTPS equipment. A-Si also has been a “safe” process for minimizing costs, since a single defect in a large screen LCD means scrapping the whole device; however, even though a-Si processes are fairly well established and controllable, it has now become clear that a-Si technology is approaching its limitations with regard to supporting the emerging demand for higher pixel densities, faster response, and brighter displays.

To date, LTPS has typically been targeted at fabricating smaller, higher performance displays because the smaller physical size of poly-silicon based TFTs allow for increased screen brightness, higher pixel density, and lower power consumption. Also, the inherently faster switching of LTPS transistors supports the requirements of video applications such as video recorders as well as video features in cell phones and PDAs.

Display manufacturers also need to plan ahead for the emergence of Organic Light Emitting Diode technology, which will become a significant segment of the display market with rapid growth projected to begin in 2007. Some simple OLED devices are already being deployed for specialized applications, such as small-screen, high brightness displays for automotive instruments and digital cameras. Several companies have announced their intention to produce large-screen OLED displays that, when productized, will gain significant market share for applications where display brightness and color is a key differentiating factor.

In OLED-based displays, the molecular structure actually emits light rather than acting as a light valve for a backlit light source, thus enabling much brighter screens. Because the light-emitting material in OLED is current-driven, rather than voltage-driven as in LCDs, the higher electron mobility and more stable current capacity of poly-silicon will be a key enabler for OLED implementation. The inherent higher luminescence of OLED also will allow designers to opt for smaller pixels to produce the same brightness, thereby enabling higher resolutions. Implementation of OLED displays will therefore be much more compatible with the smaller geometries achievable through poly-silicon.

Moving forward, display manufacturers need to deploy panel fabrication technologies that can provide high-throughput, high-yield capacity for poly-silicon production to meet today's diverse, rapidly growing LCD requirements while also laying the foundation for future, e.g., OLED market ramp-up. LCD or OLED fabrication methodology can focus on three areas: producing high-performance TFTs, yielding uniform material and devices across the entire panel, and optimizing production efficiency through a combination of high throughput and low operational costs.

The most widely used LTPS fabrication techniques involve a surface treatment that uses a laser to melt a silicon film, heating it to a liquid point over a very short time period, generally measured in nanoseconds, after which the Si film re-crystallizes into polycrystalline silicon. The primary challenges in LTPS technologies involve the effective control of the process to assure uniform crystallization across the entire panel while providing a high level of sustained process throughput and low operational costs.

The most common process used to melt the silicon is known as Excimer Laser Annealing (ELA). Low productivity and high operational expenses of the process have hampered the wide adoption of ELA. The throughput of ELA is inherently slow, with as many as 50-100 laser pulses needed to process a single spot. Using a 300W laser, the throughput for a current generation ELA system is approximately 10 panels/hr for Gen4 LCDs and only 5-6 panels/hr for Gen5.

From a performance and yield perspective, the ELA process has other significant limitations. The ELA process is based on the principle of partial melting, in which some of the silicon material toward the bottom of the layer remains in a solid state and acts as “seeds” that cause crystallization to occur vertically. This process is known to produce large variation in grain size and has a small process window. In addition, electron mobility is relatively low due to the small grain size, so the ELA process struggles to meet the requirements for System On Glass (SOG).

Another new crystallization process, known as Sequential Lateral Solidification (SLS) offers some improvement in productivity, cost, and yield. SLS is based on lateral crystal growth, where the crystallization proceeds horizontally from the edge of the molten Silicon, producing larger crystal grains with improved electron mobility. In the standard SLS technique, a mask is used to expose an area of roughly 1.2 mm×25 mm for each laser “shot”, and the substrate is processed by stepping the small exposure area over the entire glass.

Using a 300W Excimer laser, an SLS system is able to produce as many as 18 Gen4 or 10 Gen5 panels per hour. However, since the SLS mask is incrementally “stepped” to cover the panel in multiple passes, shot-to-shot variation in laser energy can lead to variability in the poly-Si throughout the panel. Stepping also can create seams due to overlap between the steps, which can be visible in a display. Further, an unwanted artifact of the standard SLS technique is the large vertical protrusions that are formed during the solidification of the Silicon. The pattern of protrusions that appear after SLS annealing can make it difficult to deposit a uniform gate dielectric layer, leading to non-uniformity in the TFT performance across the panel.

### SUMMARY

A thin beam directional crystallization system configured to anneal a silicon layer on a glass substrate can, in one embodiment, use a special short-axis laser beam profile that included an intensity peak at one edge. In another embodiment epitaxial lateral growth can be terminated at predetermined locations such that, upon the continuation of the process, epitaxial growth is re-initiated from new seeds. Thus, the crystallographic orientation of the growing grains can be randomized. Because the epitaxial lateral growth is stopped and restarted, e.g., less than every 20 micrometers or so, there will be less opportunity for texture to develop within the crystallized film. Thus uniformity of transistors made in the material can be improved.

In another embodiment step size can be intentionally varied. For example, for higher mobility poly-Si a smaller step size can be used. Alternatively, for lower mobility poly-Si a larger step size can be used. Thus, the resulting material can be matched to the desired transistor application and transistor throughput can be improved by using a higher step size when the transistor application will allow.

The system is configured to melt a portion of a silicon layer causing lateral crystal growth. By advancing the substrate, or laser, a certain per pulse step size and subjecting the silicon layer to successive “shots” from the laser, the entire silicon layer is crystallized through iterations of melting and crystal growth. The lateral crystal growth that results from each shot creates a protrusion in the center of the melt area. This protrusion can be re-melted to improve material surface flatness. Accordingly, the step size must be such that there is sufficient overlap between successive shots, i.e., melt zones, to ensure the protrusion is melted, except in cases of intentional disruptions used to eliminate or reduce the formation of texture. This can require the step size to be less than the distance of lateral growth from any single laser pulse. A step size equal to the lateral crystal growth length is the theoretical maximum step size. A smaller step size reduces throughput and increases costs. The special short-axis laser profile used in accordance with the systems and methods described herein can increase the step size, while still ensuring the protrusion is melted, and thereby increase throughput and reduce costs.

These and other features, aspects, and embodiments of the invention are described below in the section entitled “Detailed Description.”

### BRIEF DESCRIPTION OF THE FIGURES

Features, aspects, and embodiments of the inventions are described in conjunction with the attached drawings, in which:

FIG. 1 is a diagram illustrating an example cross section of a film surface after a single pulse irradiation;

FIG. 2 is a diagram illustrating another example cross section of a film surface after a single pulse irradiation;

FIG. 3 is a diagram illustrating an example position of a beam during a second irradiation of the cross section of a film surface of FIG. 1;

FIG. 4 is a diagram illustrating an example scattering of incident photons during the second irradiation illustrated in FIG. 3;

FIGS. 5A-5C are diagrams illustrating example short-axis spatial intensity profiles;

FIG. 6 is a diagram illustrating an example position of a film after “n” pulses;

FIG. 7 is a diagram illustrating a beam spatial intensity and an example position of a beam after “n+1” pulses;

FIG. 8 is an example device for manufacturing a liquid crystal display;

FIGS. 9A-9C are diagrams illustrating an example position of a beam after a number of pulses with an intentional disruption of continuous grain elongation;

FIGS. 10A and 10B are diagrams illustrating example TDX scans, one with intentional disruptions, the other with one continuous scan along the entire substrate;

FIGS. 11A and 11B are diagrams illustrating example substrates with intentional step size variations across a substrate;

FIGS. 12A and 12B are diagrams illustrating two example substrates, one example substrate with intentionally non-uniform step size and the other example substrate with a uniform step size; and

FIG. 13 is a diagram illustrating a display comprising a circuit area surrounding a display area.

### DETAILED DESCRIPTION

Thin-beam Directional Crystallization, or Thin-beam Directional ‘Xtallization (TDX), fabrication methods can combine poly-silicon's inherent advantages with efficient volume-oriented production capabilities. The end result can be superior electron mobility, flat surface topology, a large process window, and greater throughput. Different types of lasers can be used in thin-beam directional crystallization, for example, in one embodiment a solid state laser can be used. In another embodiment a high power Excimer laser can be used in the TDX process. A master oscillator power amplifier (MOPA) configuration that was originally developed for semiconductor of microlithography applications can also be used. The laser can operate at 351 nanometers and provide over 900 watts of power with exceptional pulse-to-pulse stability and high reliability. Other wavelengths can also be used, for example, 308 nanometers. Generally, any wavelength that is strongly absorbed by the material to be melted, e.g., silicon, can be used. A TDX system is described in co-pending U.S. patent application Ser. No. 10/781,251 entitled “Very High Energy, High Stability Gas Discharge Laser Surface Treatment System,” filed Feb. 18, 2004; U.S. patent application Ser. No. 10/884,101 entitled “Laser Thin Film Poly-Silicon Annealing Optical System,” filed Jul. 1, 2004; U.S. patent application Ser. No. 10/884,547 entitled “Laser Thin Film Poly-Silicon Annealing System,” filed Jul. 1, 2004; and U.S. patent application Ser. No. 11/201,877 entitled “Laser Thin Film Poly-Silicon Annealing Optical System,” filed Aug. 11, 2005, which are incorporated herein by reference as if set forth in full.

The TDX optical system used in conjunction with the systems and methods described herein can convert laser light into a very long thin uniform beam and deliver it onto the silicon film. In addition, it can be configured to stabilize the beam's energy, density and pointing; all of which can improve the consistency of the TDX process. In one embodiment, each pulse can expose an area of approximately 5 microns wide and 730 millimeters long. The length of the beam can be matched to the substrate width so that the glass is processed in a single pass. This can help to ensure a high degree of uniformity and rapid throughput. During exposure, the panel can be scanned at a constant velocity and the laser can be triggered to fire at a pitch, or step size of, e.g., 2 microns. The pitch can be chosen so that the melt region always seeds from the high quality crystals of the previous pulse, producing long directional poly-silicon crystals. Each pulse also melts the large ridge or protrusion at the center of the previous melt region, resulting in a more planar surface.

The TDX process is based on a form of controlled super lateral growth where the melt region re-solidifies laterally from the edges and towards the center. In contrast to ELA where crystal growth proceeds vertically from within the silicon layer, lateral growth produces large directional poly-silicon grains with high electron mobility. The TDX process has a much larger process window than ELA because it relies on spatially controlled complete melting of the silicon film and avoids energy sensitive partial film melting.

The use of a System on Glass (SOG) design approach is another evolving arena that is only made possible with poly-silicon. The higher electron mobility and smaller size transistors that are achievable with TDX processes described herein allow the drive electronics to be fabricated directly into the thin Si coating. This provides a powerful method to reducing panel cost and also improves panel robustness by decreasing the need for tab bond connections. Poly-silicon's much higher electron mobility allows for additional integration of drive electronics such as integrating digital-to-analog converter (DAC) on the substrate and reducing the number of drivers, e.g., by using faster drivers to control more TFT switches.

The overall cost savings with SOG can be very dramatic, especially for processing large panels that consist of many small LCD screens. Using a conventional a-Si approach with separate tab bonded drive electronics for each screen; the drive chips can comprise a significant percentage of the cost per screen as well as an expensive additional assembly step. In comparison, SOG with poly-silicon allows the drive electronics to be efficiently fabricated during the backplane manufacturing process.

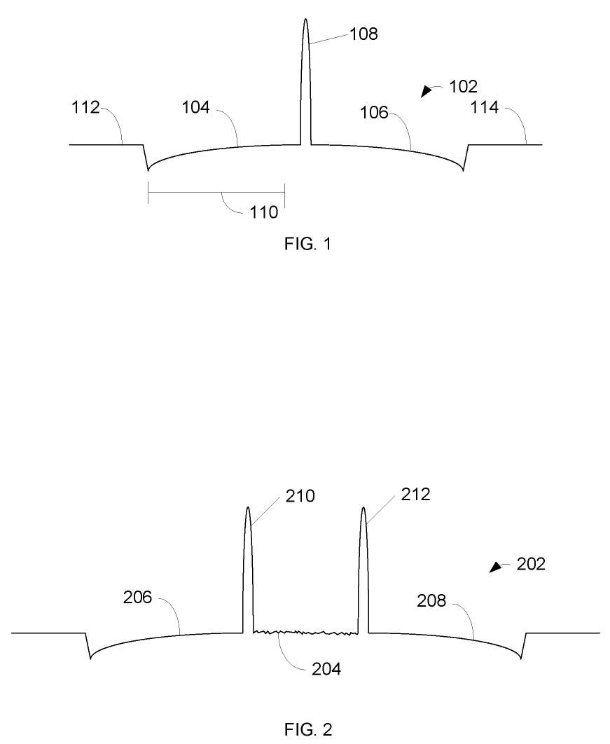

With this in mind, FIG. 1 is a diagram illustrating an example cross section of a film surface 102 after a single pulse irradiation in a thin-beam directional crystallization process in accordance with one embodiment of the systems and methods described herein. Film surface 102 can, for example, be amorphous silicon. The thin-beam irradiation melts a portion of surface 102 using a laser. The melted portion generally freezes or solidifies from the sides inward to the middle of the melted region, leaving two laterally solidified regions 104 and 106. This is because each un-melted edge of silicon film 102 acts as a “seed” on which the melted silicon can grow.

Protrusions 108 can exist at the last point of freezing generally at or near the center of the irradiated surface. Protrusion 108 can be caused when the two edges grow into each other. At or near the center where the two edges grow together the crystal structures generally will not match because each edge is “seeded” from opposite sides of the melted region and these sides originate from different randomly generated seeds. Where the two growth regions meet the crystals will push into each other and push up from the surface. The height of these protrusions 108 can be on the order of a film thickness. The film thickness is commonly about 50-100 nm, however, other film thicknesses are possible.

Protrusion 108 breaks up the uniformed crystallized structure of the surface. Further, as discussed above, the pattern of protrusions 108 that appear after annealing can also make it difficult to deposit a uniform gate dielectric layer, leading to non-uniformity in the TFT performance across the panel. In order to remove protrusion 108 it can be re-melted in the next laser shot.

For example, film surface 102 can be moved a certain step size under the laser for the next shot. The step size must be set, however, to ensure that sufficient laser energy is imported to protrusion 108 so as to ensure protrusion 108 melts. Accordingly, the need to re-melt each protrusion 108, limits the maximum step size that can be achieved. In the example of FIG. 1 the lateral growth distance is equal to about one half the width of the melt region. Therefore, the theoretical maximum step size that can be used and still ensure that protrusion 108 is melted is equal to approximately the lateral growth distance minus the width of protrusion 108.

Generally, however, the step size must be kept much less than the theoretical maximum, e.g., by several hundred nanometers where the laser pulse width is about 5 μm. The actual step size will be less than the maximum theoretical step size because greater energy is required to re-melt the protrusions 108, due to protrusion 108 being thicker than the rest of film surface 102. Additionally, protrusions 108 can scatter the laser light. So, not only will it take more energy to re-melt protrusion 108 due to its thickness, more energy will also be needed to make up for laser energy scattered by protrusion 108.

FIG. 4 is a diagram illustrating an example scattering of incident photons during irradiation. As incident photons 408 irradiate surface 102 some of those photons 402 are scattered by protrusion 108. Thus, more energy can be required to melt protrusion 108. The scattering and the extra thickness of protrusion 108 can lower the achievable step size and increase processing time, or reduce throughput of LCD manufacturing. Accordingly, a spatial intensity, short-axis profile that directs more energy at the location of protrusion 108 can be used to maximize step size 304.

It should also be noted that the laser beam width must be controlled to avoid the formation of nucleated grains 204 as illustrated in FIG. 2. Nucleated grains can occur when the center cools before the sides can grow together. When the center cools before the sides can grow together, its structure will generally not match the crystalline structure of either side, since it does not “seed” off of either side. Rather if the center cools faster than the sides can grow together it will seed vertically from within. This can occur if the melted region is too wide, i.e., the laser beam width is too wide. When the melted region is too wide the sides can not grow together before the center solidifies.

If the beam is too wide, then as lateral solidified regions 206 and 208 grow to the center nucleated region 204 and two protrusions 210 and 212 can occur. Protrusions 210 and 212 can be caused when the edges grow into nucleated region 204. The crystallized structures of each lateral solidified region 206 and 208 generally will not match nucleated region 204 because each edge is “seeded” from opposite sides of the melted region. Where the mismatched structures meet the crystals will push into each other and push up from the surface. As discussed above, it is generally preferable that the crystallized structure of an LCD formed when the film surface 202 solidifies be uniform. Protrusions 210 and 212 break up the uniform crystallized structure of the surface. Therefore, it can be advantageous to limit the beam width such that nucleated region 204 does not occur. For example, in one embodiment, the beam width is approximately 5 μm; however, it will be understood that the beam width will depend on a particular embodiment. As long as each side can grow together before nucleation occurs, the fine-grain nucleated region 204 will not occur.

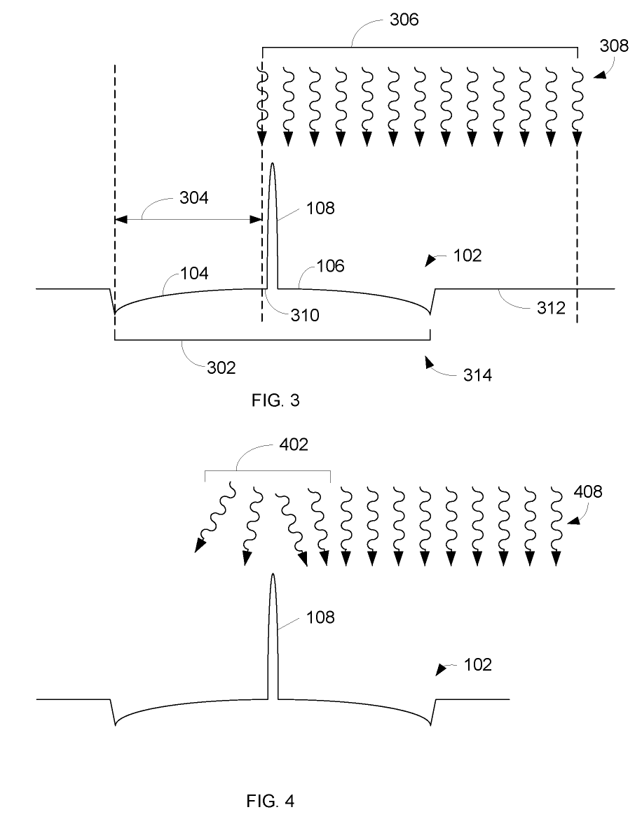

As discussed above, film surface 102 can be moved, or stepped underneath the beam to melt protrusion 108. Surface 102 can, for example, be moved to the left a little less than one half the pulse width. Protrusion 108 can then be re-melted, along with a small portion of lateral solidified region 104, all of lateral solidified region 106 and a portion of un-irradiated amorphous-Si 114. As a lateral solidified region grows from the left to the right it will seed from lateral solidified region 104, continuing the crystalline structure of lateral solidified region 104 until meeting in the middle to form a new protrusion. This can be seen with respect to FIG. 3.

FIG. 3 is a diagram illustrating an example position of a beam during a second irradiation of the cross section of a film surface of FIG. 1. The position of the beam during the first irradiation is shown at position 302. Film surface 102 can then be moved underneath the beam to melt the next section of surface 102. Surface 102 can, for example, be moved to the left a step distance 304 which can be a little less than one half the pulse width. The beam will then be positioned at 306 during the second shot, which will irradiate surface 102 with incident photons 308. Photons 308 can re-melt protrusion 108 along with a small portion 310 of lateral solidified region 104, all of lateral solidified region 106 and a portion 312 of un-irradiated amorphous-Si 114. As a new lateral solidified region grows from the left to the right it will seed from lateral solidified region 104, continuing the crystalline structure of lateral solidified region 104 until meeting in the middle of the new melt region to form a new protrusion. The new protrusion will form at approximately position 314.

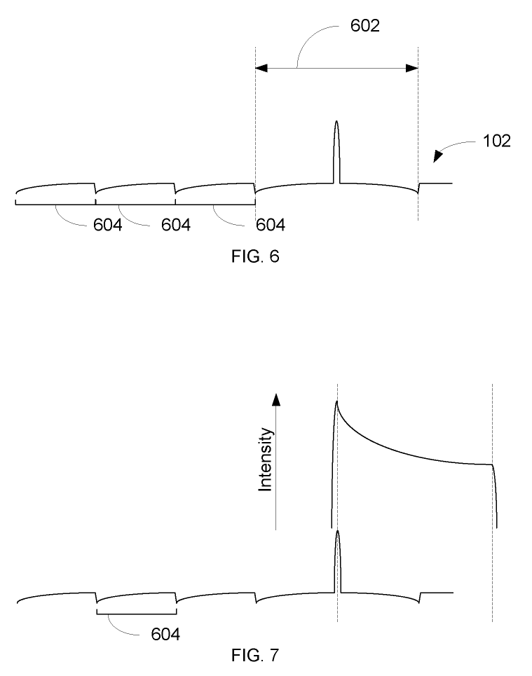

FIG. 6 is a diagram illustrating an example position 602 of a beam after “n” pulses. Film surface 102 can be moved at a constant rate. Each pulse can be timed to occur as film surface 102 moves one nominal step size 604. As can be seen, successive lateral solidification regions 604, each approximately half the length of beam width 602, are produced as the laser moves along the surface 102. As was discussed above, the nominal step size 604 is generally less than the theoretical maximum step size. But as explained below, the actual step size can be maximized by having an intensity peak near protrusion 108.

Referring to FIG. 3, step distance 304 can be less than the theoretical maximum because it takes extra energy to re-melt protrusion 108 and light can be scattered by protrusion 108. Smaller steps can increase process time and waste time re-melting area that was melted before. Small portion 310 of lateral solidified region 104 is re-melted by photons 308 from the beam. Thus, as will be understood, the larger the small portion 310, the longer it will generally take to process film surface 102. Therefore, if small portion 310 can be minimized, i.e., a larger step size can be achieved, then this can generally speed up the manufacture process leading to faster processing time and larger production volumes.

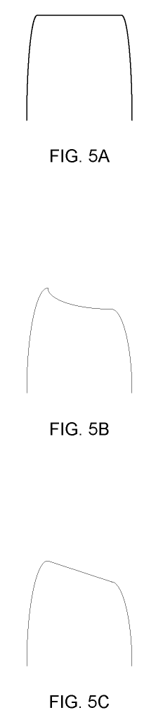

FIGS. 5A-5C are diagrams illustrating example short-axis spatial intensity profiles that can be used to direct more energy at the location of protrusion 108. FIG. 5A shows a top-hat profile. Generally, a top hat profile with steep sides, such as that illustrated in FIG. 5A, is preferable because it results in a more uniform application of energy to the surface 102; however as noted, it can be preferable to direct more energy at protrusion 108 in order to increase the step size. More energy can be directed at protrusion 108 by raising the energy density of a beam with a top hat profile such as that illustrated in FIG. 5A. But generally it is not sufficient to simply raise the energy density of the beam with a top-hat spatial profile, as this could ultimately lead to film damage or agglomeration at the side of the beam which is incident upon the amorphous-Si film.

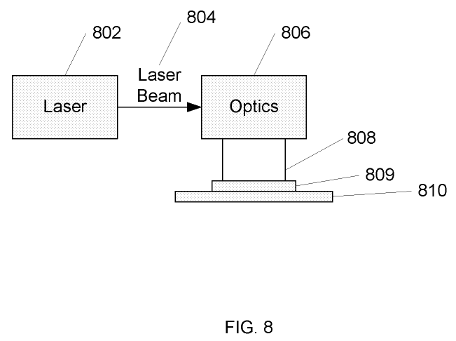

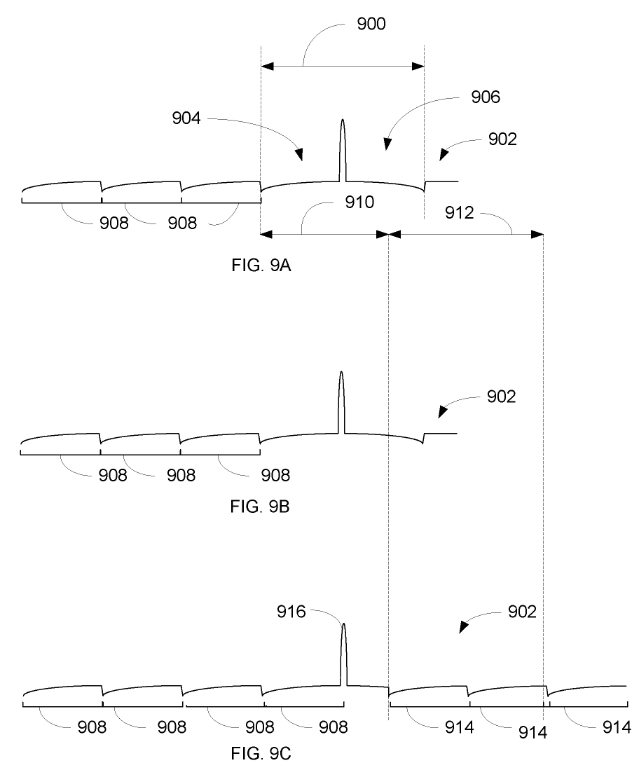

A laser beam short-axis profile that roughly correlates the intensity profile of the beam to the required melting temperature of the film can be preferred. The profile can be tailored to enable the maximum per-pulse step distance without exceeding the damage threshold. FIGS. 5B and 5C illustrate two short-axis profiles with intensity peaks occurring on the edge of the beam that correlates with the location of protrusion 108. For example, proper control of the beam delivery and beam treatment systems as illustrated in FIGS. 8 and 9 of Co-pending U.S. patent application Ser. No. 10/884,547 entitled “Laser Thin Film Poly-Silicon Annealing System,” filed Jul. 1, 2004, which is incorporated herein by reference as if set forth in full, can be used to manipulate the short-axis spatial intensity profile.

FIG. 7 is a diagram illustrating the use of a beam 712 with a short-axis, spatial intensity profile similar to that illustrated in FIG. 5B. As can be seen in FIG. 7, the intensity is highest near protrusion 108. In this way the additional energy is applied to protrusion 108. Because more energy is contained in the left hand side of the short-axis profile, the step size 704 can be increased, such that it more closely approaches the theoretical maximum, but still ensures adequate melting of protrusion 108.

In other words, by using a short axis, spatial intensity profile, such as illustrated in FIGS. 5B and 5C, portion 310 can be reduced and the step size can be increased. It will be understood that the increase in step size will depend on the implementation; however, the step size can be nearer to the theoretical maximum due to the increased intensity of the beam at the location of protrusion 108. The step size can, for example, be increased up to several hundred nanometers for a 5 μm beam width.

FIG. 8 is an example surface treatment system 800 for manufacturing a liquid crystal display in accordance with one embodiment of the systems and methods described herein. Thin-beam Directional Crystallization as described above, combines the benefits of lateral crystal growth with higher throughput, improved poly-Silicon uniformity and tailoring of the short-axis spatial intensity profile. In contrast to the standard ELA process, the Thin-beam Directional Crystallization process increases throughput while producing more uniform material.

Using a specially designed laser 802 and custom beam forming optics 804, substrate 809 can be exposed with a long thin beam 808. A beam forming optical system 804 can produce a short-axis spatial laser beam profile, e.g., as discussed above with respect to FIGS. 5A-5C. In one embodiment, long thin beam 808 can measure 5 micros wide by up to 730 mm long. This beam configuration can allow for complete coverage across the width of a glass substrate 809 during a single laser pulse. Because a 5 micro wide region is rendered completely molten, the Silicon solidifies by lateral growth crystallization, resulting in high mobility poly-Si. To process the entire substrate 809, the glass can be scanned beneath the beam 808 so that the crystallization occurs in a single pass. The glass can move at a constant velocity, and the laser can be triggered to fire after a translation of approximately 2 μm. By overlapping each new “stripe” over the previous one, a new stripe can be “seeded” from good poly-Si of the previous stripe, and the system can achieve continuous growth of a long, uniform crystal grains across the entire substrate 809.

Thin-beam Directional Crystallization with a short-axis spatial intensity profile as described above can be much more efficient than ELA, with much fewer pulses used to expose each area, e.g., less than the 20-40 pulses used in ELA. This can provide much higher panel throughput. In addition, the process window can be much larger than ELA because it does not rely on partial melting, which also helps to improve yield. Since the entire panel can be exposed in a single pass, the Thin-beam Directional Crystallization with a short-axis spatial intensity profile process as described above can also avoid the non-uniformity caused by the overlapping regions that are seen in multi-pass exposure techniques such as SLS and ELA.

The practical realization of the Thin-beam Directional Crystallization can include, for example, three major components in the system: the laser 802, the beam forming optics 804 and the stage 810. In one embodiment a specially designed high power laser 802 with a carefully chosen combination of power, pulse frequency and pulse energy to support the long beam and high scan rates can be used. This laser 802 can, for example, provide 900W of power, which is almost three times the current ELA laser power, to ensure the highest throughput. In one embodiment a laser 802 originally designed for the demanding semiconductor lithography application can be used to ensure good uniformity of the poly-Si and the TFT performance throughout the substrate.

In one embodiment stage 810 can be moved under long thin beam 808 using a stepper or translator. In this way the portion of panel 809 that is under beam 808 can be controlled so that various parts of panel 809 can be processed. In one embodiment, panel 809 can be an amorphous silicon coated glass panel. Thus, beam 808 can be used to melt a silicon film surface on panel 809.

An optical system was developed to create the optimal beam shape. In one embodiment the optimal beam shape can be long enough to cover the entire width of a substrate and narrow enough to optimize the crystallization process. Particular care can be taken with the design of the projection optics contained in the optical system to ensure thermal stability and controlled Depth of Focus (DOF) under high power loads, and to maximize the optics lifetime.

In one embodiment, to ensure rapid motion in the scan direction, the laser must operate at a high repetition rate, for example, at 6 kHz, and the stage speed can, e.g., be 12 mm/sec for an approximately 2 micro pitch. The substrate can be exposed in a single pass, which requires approximately a 150 mJ/pulse to expose a Gen4 substrate. In one embodiment a thin beam crystallization system with a 6 kHz, 900W laser can process an entire Gen4 panel in as little as 75 seconds.

A more detailed explanation of example embodiments of a surface treatment system 800 that can be used in accordance with the systems and methods described herein are described in U.S. application Ser. Nos. 10/781,251; 10/884,101; 10/884,547; and 11/201,877.

At the onset of crystal growth in, e.g., TDX processing of silicon films, crystallographic orientation of the film is generally random due to random formation of crystalline seeds within an amorphous film. On each pulse of the process, one side of the melted silicon formed by beam irradiation re-solidifies laterally and epitaxially from grains grown on previous iterations. The other side grows laterally from newly formed seeds from the initially amorphous portion of the film under the beam. As the beam and/or substrate are moved relative to each other.

As a beam scans across an, e.g., amorphous silicon coated glass panel the TDX process can induce crystallographic texture in the scan direction, normal to the film, or both. The crystallographic texture is formed because as the panel moved under the beam or the beam moves across the panel one side of the molten silicon zone formed by the beam irradiation re-solidifies laterally and epitaxially from grains grown on previous iterations. Thus, as the beam scans across the amorphous silicon coated glass panel a crystallographic texture can form because with each shot a portion of silicon seeds from the portion before it.

FIG. 9A is a diagram illustrating an example position 900 of a beam after “n” pulses. As the beam moves across film surface 902 each pulse can be timed to occur as film surface 902 moves a nominal step size. As discussed above, on each pulse, one side 904 of the molten silicon formed by the beam irradiation re-solidifies laterally and epitaxially from the grains grown on previous iterations. The opposite side 906 grows laterally from newly formed seeds from the initially amorphous portion of the film under the beam. Opposite side 906 can ultimately be re-melted by subsequent pulses. Because side 904 re-solidifies laterally and epitaxially from grains grown on previous iterations a crystallographic “texture” can form in solidification regions 908.

In other words, because the process described above produces directionally solidified material, e.g., polycrystalline silicon, the material produced can include a “texture,” since texture often evolves in directionally solidified material. Such texture can occur in the scan direction, normal to the scan direction, or both. The texture produced can depend on the material, the film thickness, process variables, and phase transformation. For example, in a TDX process, texture development can be effected by the step size, the incident energy density, the shape of the laser beam intensity profile, the user wavelength, and the laser pulse duration.

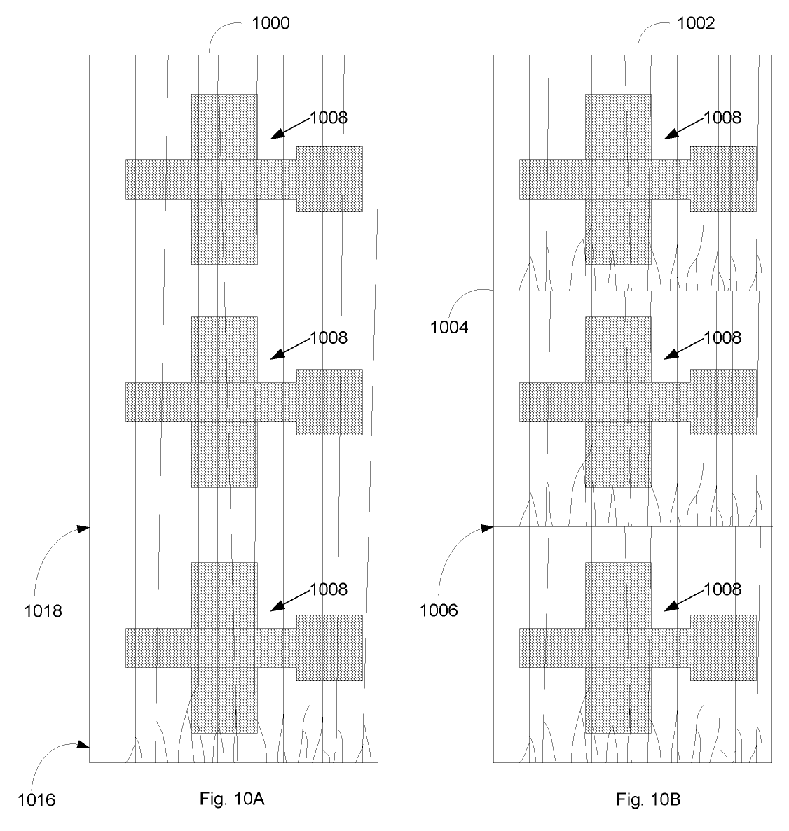

As illustrated in FIG. 10A, at the onset of crystal growth, e.g., in TDX processing of a silicon film, the crystallgraphic orientations are random, due to the random formation of crystalline seeds. This random formation extends over a portion 1016 of the film. As the process continues, however, the crystrallization becomes more uniform, in portion 1018, as one side 904 of the molten zone resolidifies laterally and epitaxially from grains grown on the previous iteration. As explained above, this process produces long, uniform grains as illustrated in portion 1018 of FIG. 10A.

But as the long grains are formed, the texture can vary across portion 1018. This variation in texture can produce non-uniformity in the performance of transistors 1008 formed on treated film 1000. In other words, variations in texture can result in variations in mobility and other parameters that effect transistor 1008 performance. This decreases the uniformity of transistor 1008 performance, which can have a negative impact on display performance.

In certain embodiments crystallographic texture formation can be stopped by disrupting the epitaxial lateral growth at predetermined locations. By disrupting the epitaxial lateral growth, subsequent epitaxial lateral growth in each new section is re-initiated from new seeds, thereby randomizing the crystallographic orientation of the growing grains.

FIG. 9B is a diagram illustrating, in conjunction with FIGS. 9A and 9C, an example process for treating a film 902 in accordance with one embodiment that uses an intentional overshoot to disrupt lateral growth in film 902. By introducing an intentional step overshoot 910 the crystallographic texture of solidification regions 908 can be broken up. After the “n-th” pulse the beam can be repositioned to position 912, leaving a gap between solidification regions 908. This gap can be referred to as a controlled overshoot, because the, e.g., amorphous silicon coated glass panel can be allowed to move farther along before the next irradiation occurs. In one embodiment the amorphous silicon coated glass panel can move at a constant rate, while the timing of an irradiation can be controlled to leave a gap.

As shown in FIG. 9C subsequent pulses of the beam forms lateral solidification regions 914, wherein the crystallographic orientations are again randomized and the texturing begins anew. This can be illustrated with the aid of the diagram depicted in FIG. 10B. FIG. 10B illustrates crystallization of a film 1002 with intentional overshoots introduced at boundaries 1004 and 1006. As can be seen, after each overshoot, crystallizations again randomize and then texturing begins anew.

In one embodiment epitaxial lateral growth can be stopped and restarted approximately every 10-20 micrometers, or with a pitch that is matched to the layout of transistor 1008. Referring to FIGS. 9A-9C, a peak 916 can be produced as a result of the overshoot; however, the formation of peaks 916 should not effect performance since the active areas of transistors 1008 are not formed across boundaries 1004 and 1006, where a peak 916 will occur. Thus, there will be less opportunity for texture to develop within crystallized film 1002 and the uniformity of transistors 1008 can be maximized. In another embodiment the controlled overshoot can occur approximately every 10 micros.

Crystallized film 1000 of FIG. 10A will exhibit high mobility due to the superior quality of crystalline structure created via the TDX process described above. Accordingly, crystallized film 1000 can be preferred for formation of transistors in circuit areas. Conversely, crystallized film 1002 of FIG. 10B will exhibit better uniformity, which can make it preferable for formation of TFTs in the display area. Accordingly, it can be preferable to combine the two processes used to produce crystallized films 1000 and 1002 in the formation of a display panel. In other words, it can be preferable to produce high quality crystallized film, such as film 1000, for display circuit areas and a more uniform crystallized film, such as film 1002, for the display area itself.

The performance of TFT's 1008 formed on film 1002 will not be as good as transistors formed on film 1000, due to the lower quality of film 1002; however, it has been shown that uniformity is more important for the display area, whereas quality is more important for transistors formed in the circuit area. Thus, by selectively including both types of films, performance for both regions can be better optimized.

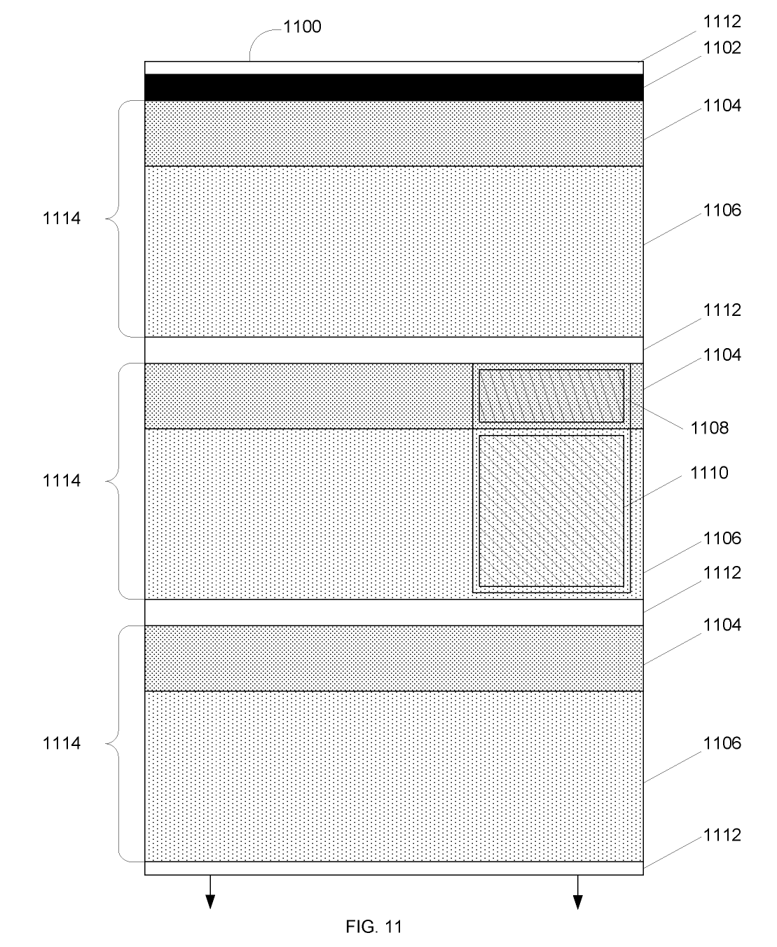

Accordingly, when processing a panel, variations in the process can be used for different areas to optimize overall performance by trading off quality versus uniformity. For example, high quality crystallized film for display circuit areas and more uniform crystal film for display area. FIG. 11 is a diagram illustrating a panel 1100 that has been treated using a variable process in accordance with one embodiment. Panel 1100 can be a glass panel with an a-Si film formed thereon. In the example of FIG. 11, several regions 1114 are produced from panel 1100. Each region 1114 can be separated by an untreated a-Si region 1112. Additionally, each region 1114 can comprises a high mobility, e.g., high quality, region 1104, which can be used to form circuit regions 1108, and a lower mobility, but more uniform region 1106 used to form display regions 1110.

Panel 1100 can be processed, e.g., from bottom to top by moving panel 1100 under laser beam 1102 in the direction of the arrows shown at the bottom. The step size for each shot of beam 1102 can be varied as required to produce regions 1104 and 1106. This can be done by varying the rate of translation of panel 1100. In other embodiments, panel 1100 can move at a constant rate while the firing rate of laser 1102 is varied, i.e., to produce intentional overshoots 910 in region 1106.

For example, the placement of circuit area 1108 and display area 1110 can be based on a predetermined layout or mapping of panel 1100. This layout or mapping can be pre-loaded or continuously fed to a controller such that step distances between laser pulses can be varied on a shot by shot basis. One or more panels 1100 can then be processed using the predetermined layout of panel 1100 to guide what process is used in areas 1108 and 1110 of panel 1100.

For example, OLED displays can require a high degree of uniformity from the pixel addressing TFTs, while high performance is generally not necessary. Thus, in one embodiment, a step size larger than the lateral growth length can be used to process a display area 1110. Generally while the step size can be larger than the lateral growth length, it can also be less than twice the lateral growth length. For example, display area 1110 can have a step size to optimize uniformity, e.g., between approximately 2.5 and 3.5 μm for a beam width of 5 μm. Conversely, the digital circuit area 1108 is generally not going to be seen and therefore, visual artifacts are generally not important. Performance can, however, be important in the digital circuit area 1108 because, for example, high performance can lead to higher speed digital circuits. Thus, a step size that is less than the lateral growth length can be used. For example digital circuit area 1108 can use a step size of less than 1 μm. Crystallization can still take place in a single pass.

In one embodiment no reprogramming is necessary during the scan because triggering the laser pulse 1102 to fire can occur as panel 1100 moves under the beam and the different step sizes can be accomplished by, e.g., changing the timing of laser pulses 1102 and/or the rate at which the panel moves relative to the laser and/or the laser moves relative to the panel. Additionally, areas that do not require crystalline material can be left un-irradiated.

While examples that use a thin-beam directional crystallization process to process amorphous silicon glass panels it will be understood that any directional solidification process where step-size influences the resulting polycrystalline material's uniformity and quality, i.e., grain size, crystallographic orientation, etc. can benefit from the systems and methods described herein.

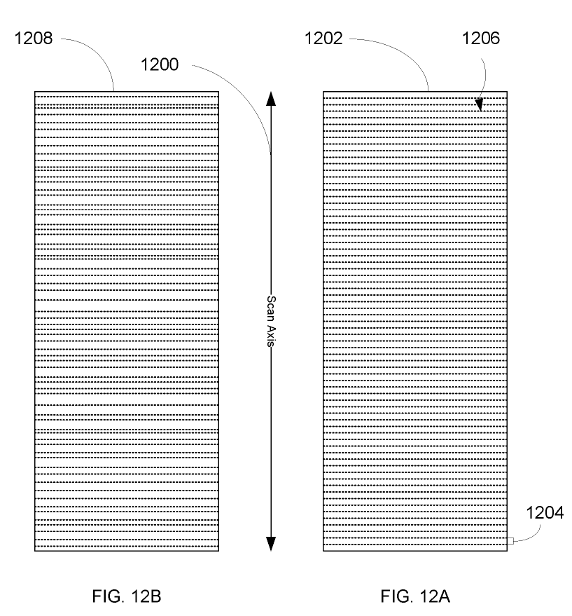

In other embodiments, the ability to control the step size can be used to improve the quality of a display. For example, when a uniform step size is used, a periodic stripped pattern can be produced that can be visible to the viewer in the display area. The stripped pattern is produced by the overlapping application of the laser. As seen in FIG. 6, regions 603 are not continuous, but include a periodic shape. As viewed above, this periodic shape can be seen as a stripe pattern as illustrated in FIG. 12A.

FIG. 12A is a diagram illustrating a TDX scan 1202 with a constant step distance 1204 and FIG. 12B is a diagram illustrating a TDX scan 1208 with an intentional non-uniformed step distance. Each scan 1202 and 1208 can occur along scan axis 1200. Scan 1202 has a constant step distance, thus each dotted line 1206 can indicate shot marks from the edge of the overlap area. Depending on step distance 1204 the next shot can overlap with the last shot.

A TDX scan with a constant step size 1202 will generally be repetitive. If a display surface is too repetitive the eye can pick up small flaws in the surface. Further, flaws in the surface may be repeated due to the uniformity of the scan. To make any flaws in the display surface more difficult for the eye to pick up a TDX scan with intentional non-uniform step distance can be used. The non-uniform step distance can help to disrupt any visual effect perceived in, e.g., an LCD or OLED display due to an otherwise constant and thus periodically appearing step distance. In one embodiment the step size can be varied within a certain range, e.g., 1 to 2 μm. In another embodiment the step size can by a certain range, e.g., 1 to 2 μm.

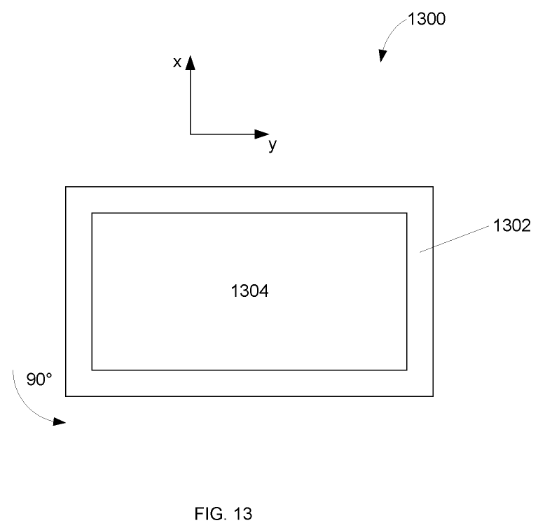

FIG. 13 is a diagram illustrating a display 1300 comprising a circuit area 1302 surrounding a display area 1304. As explained above, a different scan rate, or pattern can be used for circuit area 1302 and display area 1304 to optimize performance; however, this would normally require two scans, one along the x axis and one along the y axis. This can require scanning in one direction, e.g., in the x direction, removing the panel, rotating the panel 90°, and then re-scanning in the same direction to form the remaining circuit area; however, by using a stage that can rotate the panel 90°, formation of circuit area 1302 and display area 1304 can be achieved quickly and efficiently.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed is:

1. A device for processing substrates comprising:
a laser configured to produce laser light periodically;
beam shaping optics coupled to the laser and configured to convert the laser light emitted from the laser into a long thin beam with a short axis and a long axis; and
a stage configured to support the substrate; and
a translator coupled with the stage, the translator configured to advance the substrate so as to produce a step size in conjunction with the periodic firing of the laser, the translator and the laser further configured to cause an intentionally step overshoot.

2. The device of claim 1, wherein a second intentional step overshoot is caused approximately 10 μm from a first intentional step overshoot.

3. The device of claim 1, wherein a second intentional step overshoot is caused approximately 20 μm from a first intentional step overshoot.

4. The device of claim 1, wherein a second intentional step overshoot is caused after a first intentional step overshoot such that at least one electronic device can be formed between the first and second intentional overshoot on a substrate processed using the device.

5. The device of claim 4, wherein the electronic device comprises a transistor.

6. The device of claim 1, wherein an intentional step overshoot is caused at a predetermined location.

7. The device of claim 6, wherein the predetermined location is determined based on a predetermined design.

8. The device of claim 6, further configured to rotate the stage.

9. The device of claim 8, wherein the stage can rotate 90 degrees.

10. The device of claim 1, wherein the beam profile in the short axis has more energy near an edge of the beam that corresponds to a protrusion in a silicon film on the substrate.

11. A device for processing substrates comprising:
a laser configured to produce laser light periodically;
beam shaping optics coupled to the laser and configured to convert the laser light emitted from the laser into a long thin beam with a short axis and a long axis; and
a stage configured to support the substrate; and
a translator coupled with the stage, the translator configured to advance the substrate so as to produce a step size in conjunction with the periodic firing of the laser, wherein the step size can be varied between at least two distance settings.

12. The device of claim 11, wherein at least one distance setting is less than the lateral growth length.

13. The device of claim 11, wherein at least one distance setting is greater than the lateral growth length.

14. The device of claim 11, wherein at least one distance setting is less than twice the lateral growth length.

15. The device of claim 11, wherein the beam profile in the short axis has more energy near an edge of the beam that corresponds to a protrusion in a silicon film on the substrate.

16. The device of claim 11, wherein one distance setting is used at a set of predetermined locations to process a predetermined area.

17. The device of claim 16, wherein the predetermined area is determined by a predetermined design.

18. A device for processing silicon films comprising:
a laser configured to produce laser light periodically;
beam shaping optics coupled to the laser and configured to convert the laser light emitted from the laser into a long thin beam with a short axis and a long axis; and
a stage configured to support the substrate; and
a translator coupled with the stage, the translator configured to advance the substrate so as to produce a step size in conjunction with the periodic firing of the laser, the translator and the laser further configured to cause an intentionally non-uniformed step distance.

19. The device of claim 18, wherein the non-uniformed step size is varied by a range between 1 μm and 2 μm.

20. The device of claim 18, wherein the non-uniformed step size is varied between 1 μm and 2 μm.

21. The device of claim 18, wherein the beam profile in the short axis has more energy near an edge of the beam that corresponds to a protrusion in a silicon film on the substrate.

22. The device of claim 18, further configured to operate in a mode wherein the step distance is uniformed.

23. The device of claim 22, wherein the device is configured to operate in a mode wherein the step distance is non-uniformed when processing a display area.

24. The device of claim 22, wherein the device is configured to operate in the mode wherein the step distance is uniformed when processing a non-display area.
